(19) United States
(12) Patent Application Publication
(10) Pub. No.: US 2013/0087175 A1
(43) Pub. Date: Apr. 11, 2013

(54) Aircraft Washing System

(71) Applicants: Matthew J. Petter, South Haven, MI (US); Douglas A. Petter, South Haven, MI (US)

(72) Inventors: Matthew J. Petter, South Haven, MI (US); Douglas A. Petter, South Haven, MI (US)

(73) Assignee: Petter Investments, Inc. d/b/a Riveer Co, South Haven, MI (US)

(21) Appl. No.: 13/253,716

(22) Filed: Oct. 5, 2011

(51) Int. Cl. B08B 3/02; B08B 7/04

(52) U.S. Cl. 134/36; 134/123; 134/105

(57) ABSTRACT

A vehicle maintenance system is disclosed having a power unit, a pump, a foam generator, an air compressor, first and second fluid tanks, a hose reel assembly, a wash gun assembly and a support member.

### FIELD OF THE INVENTION

The disclosure relates to an aircraft washing system.

### DESCRIPTION OF THE RELATED ART

Washing systems are known in the art. Improvements to washing systems are continuously being sought in order to advance the art.

### BRIEF DESCRIPTION OF THE DRAWINGS

The disclosure will now be described, by way of example, with reference to the accompanying drawings, in which:

FIG. 1 is an exploded view of an aircraft washing system according to an embodiment.

FIG. 2A is a left-side, assembled perspective view of the aircraft washing system of FIG. 1.

FIG. 2B is a right-side, assembled perspective view of the aircraft washing system of FIG. 1.

FIG. 3 is a right side, assembled view of the aircraft washing system of FIG. 1.

FIG. 4 is a top side, assembled view of the aircraft washing system of FIG. 1.

FIG. 5 is a rear side, assembled view of the aircraft washing system of FIG. 1.

FIG. 6A is a perspective view of a first fluid tank of the aircraft washing system of FIG. 1 according to an embodiment.

FIG. 6B is a side view of the first fluid tank of FIG. 6A according to an embodiment.

FIG. 6C is a rear view of the first fluid tank of FIG. 6A according to an embodiment.

FIG. 6D is an enlarged view according to line 6D of FIG. 6A.

FIG. 7A is an exploded perspective view of a second fluid tank/a third fluid tank of the aircraft washing system of FIG. 1 according to an embodiment.

FIG. 7B is an assembled perspective view of the second fluid tank/third fluid tank of FIG. 7B.

FIG. 8 illustrates an enlarged view of the aircraft washing system according to line 8 of FIG. 2B.

FIG. 9A illustrates a partially exploded view of a burner unit of the aircraft washing system of FIG. 1 according to an embodiment.

FIG. 9B illustrates an assembled, side view of the burner unit of FIG. 9A.

FIG. 10A illustrates a partial exploded perspective view of a first reel assembly of the aircraft washing system of FIG. 1 according to an embodiment.

FIG. 10B illustrates an assembled rear view of the first reel assembly of FIG. 10A.

FIG. 11A illustrates a partial exploded perspective view of a second reel assembly of the aircraft washing system of FIG. 1 according to an embodiment.

FIG. 11B illustrates an assembled rear view of the second reel assembly of FIG. 11A.

FIG. 12A illustrates a partial exploded perspective view of a third reel assembly/a fourth reel assembly of the aircraft washing system of FIG. 1 according to an embodiment.

FIG. 12B illustrates an assembled rear view of the third reel assembly/the fourth reel assembly of FIG. 12A.

FIG. 13A illustrates a partial exploded perspective view of a fifth reel assembly of the aircraft washing system of FIG. 1 according to an embodiment.

FIG. 13B illustrates an assembled rear view of the fifth reel assembly of FIG. 13A.

FIG. 14 illustrates an exploded perspective view of a first high pressure wash assembly/a second high pressure wash assembly of the aircraft washing system of FIG. 1 according to an embodiment.

FIG. 15A illustrates an exploded perspective view of a wash gun assembly of the aircraft washing system of FIG. 1 according to an embodiment.

FIG. 15B illustrates an assembled perspective view of the wash gun assembly of FIG. 15A.

FIG. 16 is a fluid circuit diagram of the aircraft washing system of FIG. 1 according to an embodiment.

### DETAILED DESCRIPTION OF THE INVENTION

The Figures illustrate an exemplary embodiment of an aircraft washing system in accordance with an embodiment of the invention. Based on the foregoing, it is to be generally understood that the nomenclature used herein is simply for convenience and the terms used to describe the invention should be given the broadest meaning by one of ordinary skill in the art.

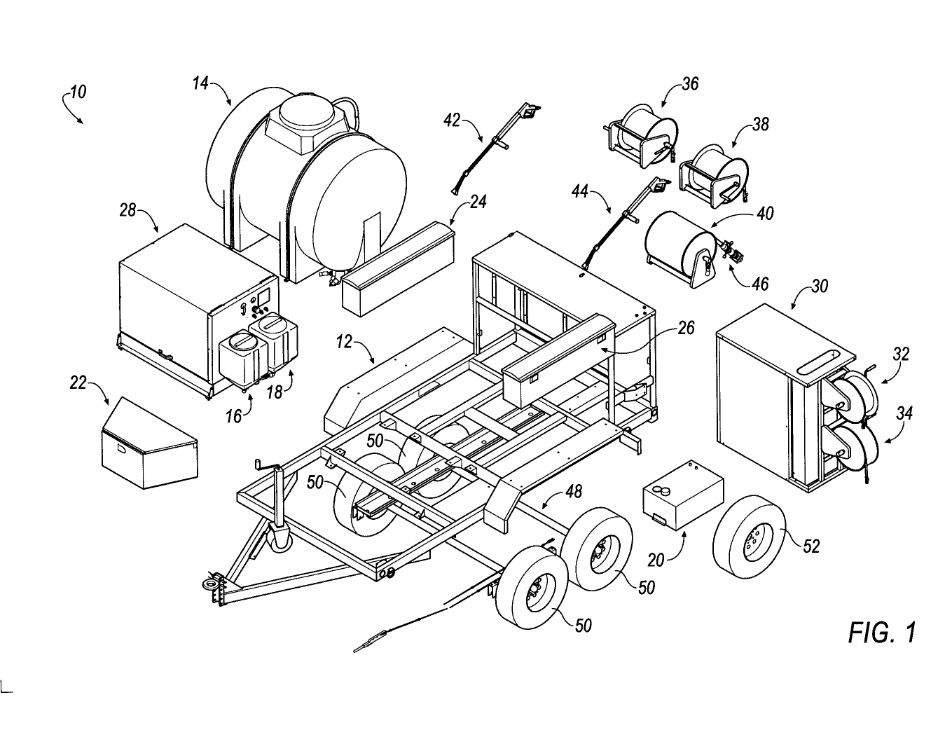

An aircraft washing system for washing an aircraft (not shown) is shown generally at 10 at FIG. 1 according to an embodiment of the invention. The aircraft may include, but is not limited to: a helicopter, an airplane or the like. Although an aircraft may be utilized in conjunction with the system 10, the system 10 may treat other vehicles including, but not limited to: land or sea vehicles, such as, for example, cars, trucks, boats or the like.

The system 10 may be commercially available and sold under the trade name TAWS® (“Total Aircraft Wash System”) by Riveer Environmental of South Haven, Mich. The system 10 may be an integrated and self-contained device that performs several functions in the maintenance (e.g., washing) of an aircraft while mitigating corrosion of the aircraft.

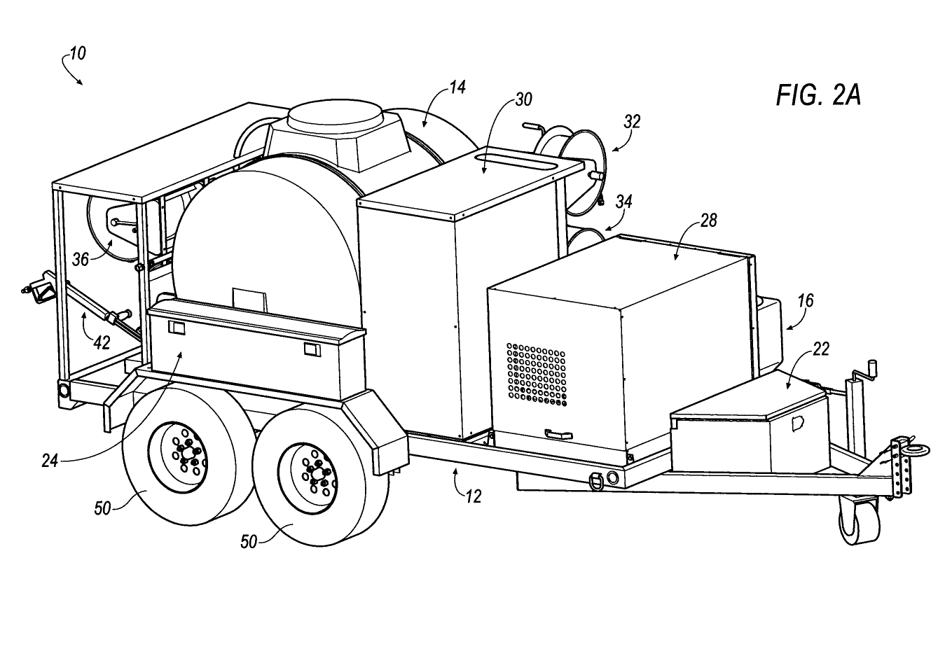

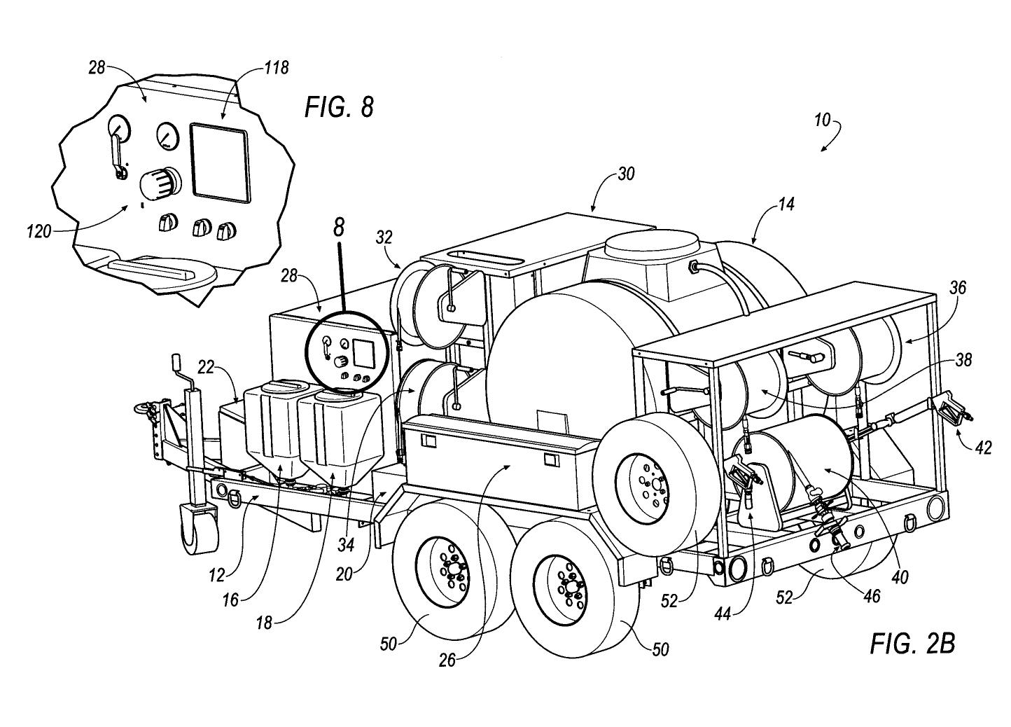

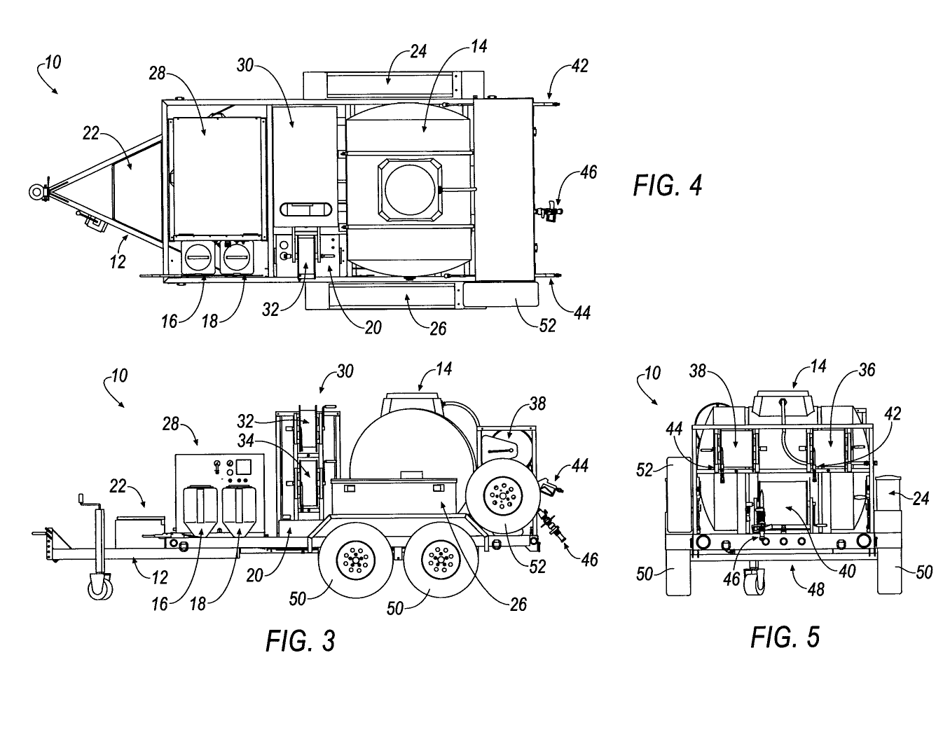

Referring to one or more of FIGS. 1-5, the system 10 may include a member 12 that supports and is connected to a plurality a components 14-52 including, but not limited to: a first fluid tank 14, a second fluid tank 16, a third fluid tank 18, a fourth fluid tank 20, a first storage unit 22, a second storage unit 24, a third storage unit 26, a power unit 28, a burner unit 30, a first reel assembly 32, a second reel assembly 34, a third reel assembly 36, a fourth reel assembly 38, a fifth reel assembly 40, a first high pressure wash assembly 42, a second high pressure wash assembly 44 and a wash gun assembly 46. The member 12 may be a trailer that is supported by, for example, a tandem axle assembly 48 including a plurality of tires 50 in order to permit the system 10 to be, for example, connected to and towed by a vehicle (e.g., a truck) such that the system 10 is mobilized. Because the system 10 may employ tires 50, should one of the tires 50 become flat, the member 12 may also support and be connected to one or more spare tires 52.

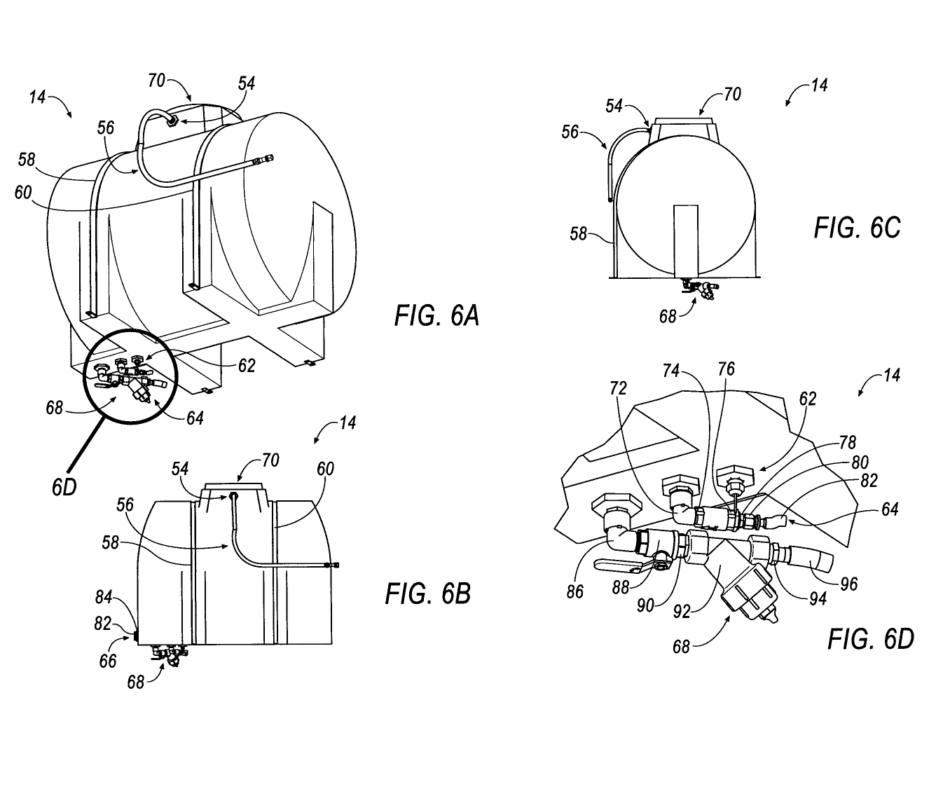

Referring to FIGS. 6A-6D, the first fluid tank 14 may include a storage capacity of approximately about 525-gallons for storing a fluid. The fluid stored by the first fluid tank 14 may include water.

The first fluid tank 14 may be connected to a plurality a components 54-70. Referring to FIG. 6A, the plurality of components 54-70 may include, but is not limited to: a refill port 54, a refill hose 56, a first tie-down hoop 58, a second tie-down hoop 60, a low-float protector assembly 62, a pressure washer bypass inlet assembly 64, a first outlet assembly 66, a second outlet assembly 68 and a man-hole access port cover 70.

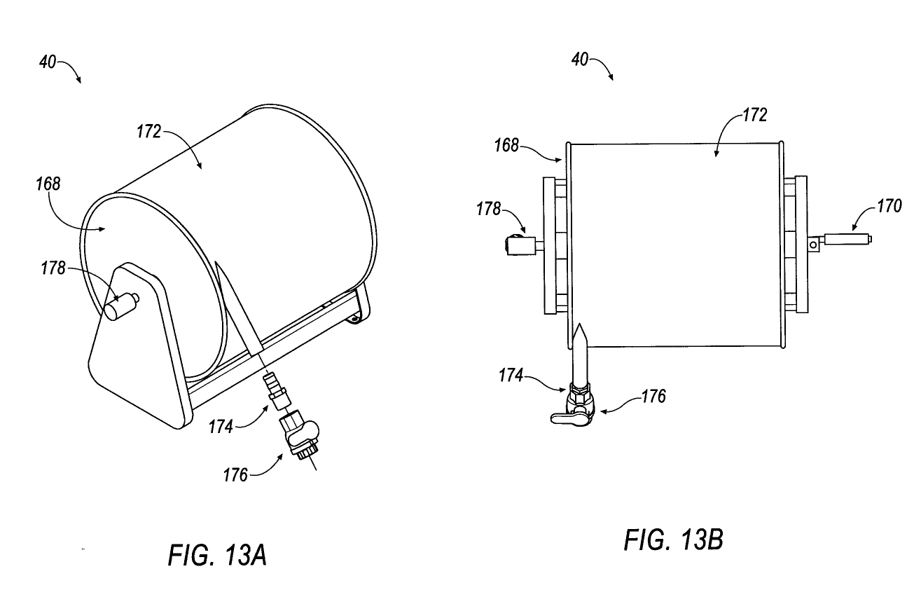

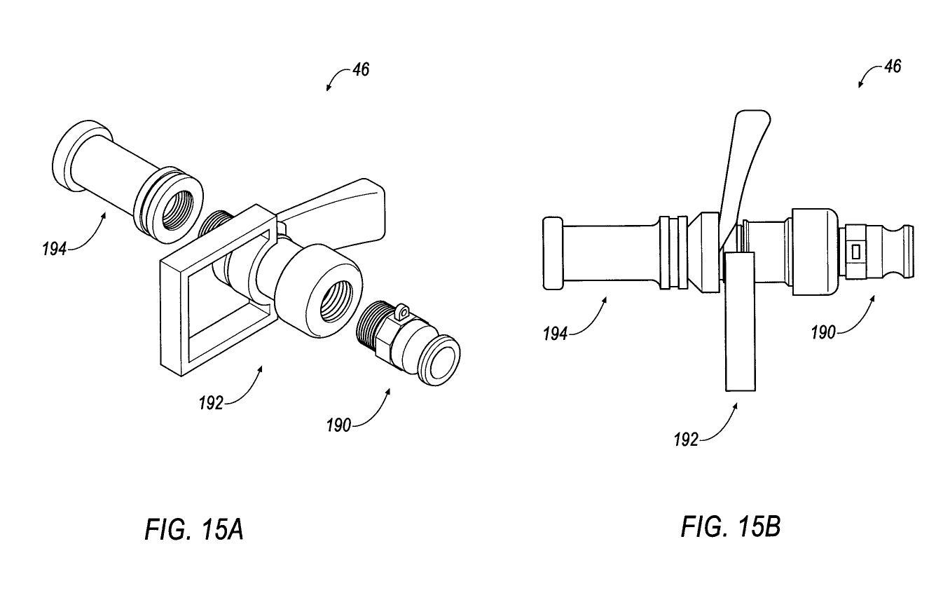

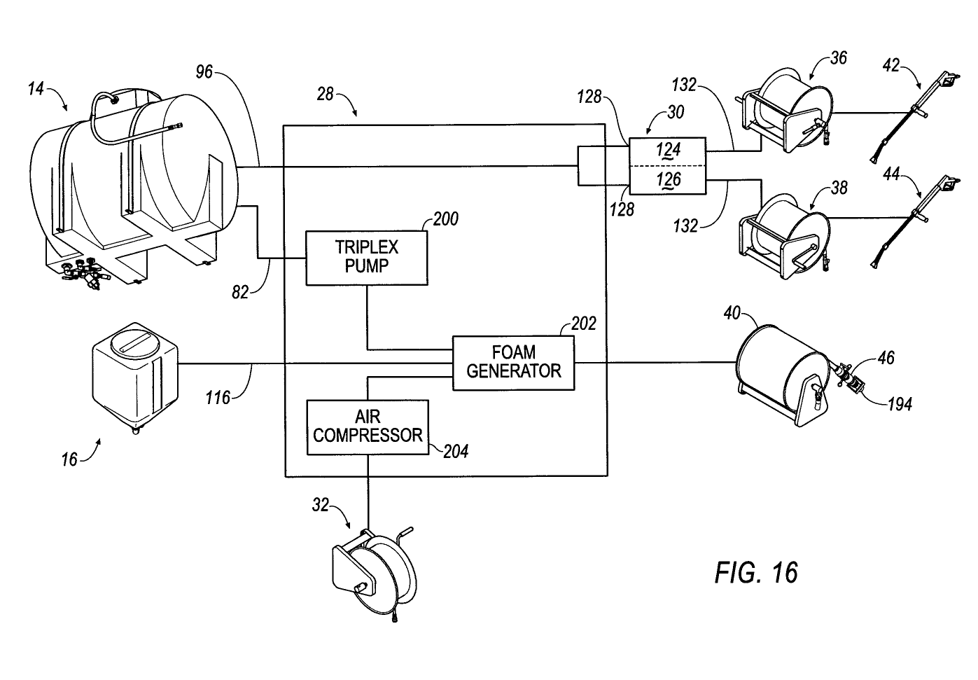

Referring to FIG. 6D, the pressure washer bypass inlet assembly 64 is described according to an embodiment at reference numerals 72-80. A street elbow 72 is connected to a check valve 74. A reducing bushing 76 is connected to the check valve 74. An adapter 78 is connected to the reducing bushing 76. A swivel fitting 80 is connected to the adapter 78. A hose 82 is connected to the swivel fitting 80. The hose 82 connects the pressure washer bypass inlet assembly 64 to, for example, the triplex pump 200 (see, e.g., FIG. 16) in the power unit 28; as will be explained in the following disclosure, water from the triplex pump 200 may be provided along with, for example, soap and compressed air to a foam generator 202 (see, e.g., FIG. 16) of the power unit 28. The foam generator 202 creates foam that is directed to the hose reel assembly 40 (see, e.g., FIGS. 13A-13B), which is connected to the wash gun assembly 46 (see, e.g., FIGS. 15A-15B) that includes an outlet foamer nozzle 194 for washing the aircraft.

The first outlet assembly 66 may include a plug 82 and a port 84. The plug 82 may be inserted into the port 84 for closing-out and sealing the port 84.

The second outlet assembly 68 is described according to an embodiment at reference numerals 86-94. A street elbow 86 is connected to a ball valve 88. A poly close 90 is connected to the ball valve 88. A Y-strainer 92 is connected to the poly close 90. A hose barb 94 is connected to the Y-strainer 92. A hose 96 is connected to the hose barb 94. The hose 96 connects the second outlet assembly 68 to an inlet port 128 of each of the first burner 124 and the second burner 126 may include an inlet port 128.

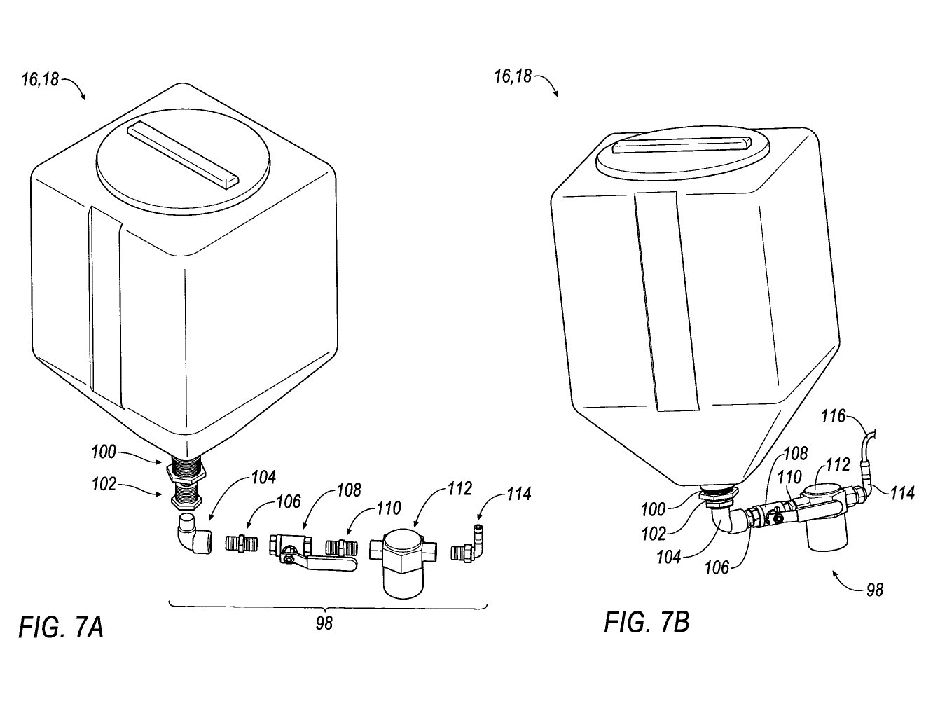

Referring to FIGS. 7A-7B, one or both of the second fluid tank 16 and the third fluid tank 18 may include a storage capacity of approximately about 10-gallons for storing a fluid. The fluid stored by the second fluid tank 16 may include soap concentrate solution. The fluid stored by the third fluid tank 18 may include gas path cleaner solution.

Each of the second and third fluid tanks 16, 18 may including a removable top lid 99 and an outlet assembly 98 including a plurality a components 100-114. The plurality of components 100-114 may include, but is not limited to: a reducing bushing 100, a bushing poly 102, a street elbow 104, a first poly close 106, a ball valve 108, a second poly close 110, a line strainer 112 and a hose barb 114.

The reducing bushing 100 is connected to the bushing poly 102. The bushing poly 102 is connected to the street elbow 104. The street elbow 104 is connected to the first poly close 106. The first poly close 106 is connected to the ball valve 108. The ball valve 108 is connected to the second poly close 110. The second poly close 110 is connected to the line strainer 112. The line strainer 112 is connected to the hose barb 114. The hose barb 114 is connected to a hose 116.

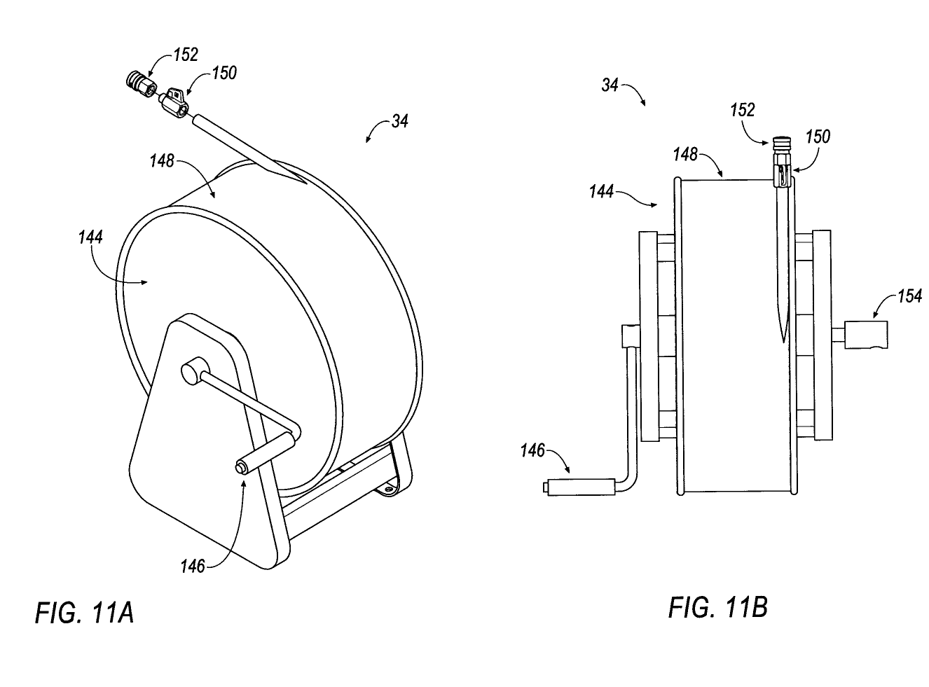

Referring to FIG. 16, the hose 116 that is associated with the second fluid tank 16 may be connected to the foam generator 202 in the power unit 28. As explained above, the foam generator 202 accepts water, soap and compressed air for creating foam that is subsequently directed to the hose reel assembly 40, which is connected to the wash gun assembly 46 that includes an outlet foamer nozzle 194. The hose 116 that is associated with the third fluid tank 18 may connect the third fluid tank 18 to the inlet port 154 (see, e.g., FIG. 11B) of the engine flush hose reel assembly 34 (see, e.g., FIGS. 11A-11B).

Referring to FIGS. 1, 2B, and 3-4, the fourth fluid tank 20 may include a storage capacity for storing a fluid. The fluid stored by the fourth fluid tank 20 may include fuel. The fuel may include any desirable fuel, such as, for example, gasoline, diesel, ethanol, methane, natural gas or the like.

Referring to FIGS. 1-4, the power unit 28 may include any desirable type of energy resource, such as, for example, one or more of a battery (that stores an amount of electrical charge) and a prime mover (i.e., an engine). If the power unit 28 includes an engine, the engine may operate on the fuel supplied by the fourth fluid tank 20.

In an embodiment, the power unit 28 may include a 2-cylinder, 14.5-horse-power, water-cooled, tier-4 diesel engine. The power unit 28 may also include one or more components connected to and powered by the energy resource (e.g., the diesel engine); the one or more components may include, but is not limited to: a 12-gallon-per-minute triplex water pump 200 (see, e.g., FIG. 16), a 2.5-gallon-per-minute engine flush pump, a foam generator 202 (see, e.g., FIG. 16) and an air compressor 204 (see, e.g., FIG. 16).

The triplex pump 200 may include a preset pressure regulator in order to maintain outlet nozzle pressure (of the first high pressure wash assembly 42, the second high pressure wash assembly 44 and the wash gun assembly 46) to be not more than about 175 psi. The triplex pump 200 may also include an output that is used to drive an air compressor. The air compressor 204 may be connected to the foam generator 202 in order to contribute compressed air (along with supplied water and soap) to the foam generator 202 in order to produce a foam washing solution.

Referring to FIG. 8, the power unit 28 may be equipped with a control panel 118 and a plurality of operator input devices 120 including one or more buttons, knobs, switches, dials and the like connected to the control panel 118. The one or more operator input devices 120 permit an operator to manipulate one or more operational conditions of the system 10.

A controller (not shown) may be disposed with the power unit 28 for receiving the operator inputs from one or more of the plurality of operator input devices 120. The controller may also monitor all of the functions associated with the system 10 such as, for example: water temperature, oil pressure, voltage and a low float input from the first fluid tank 14, and the like. In the event that one of the monitored parameters of the system 10 is not normal, the controller may shut down the engine. All operational controls and indicators are located on the control panel for operator convenience.

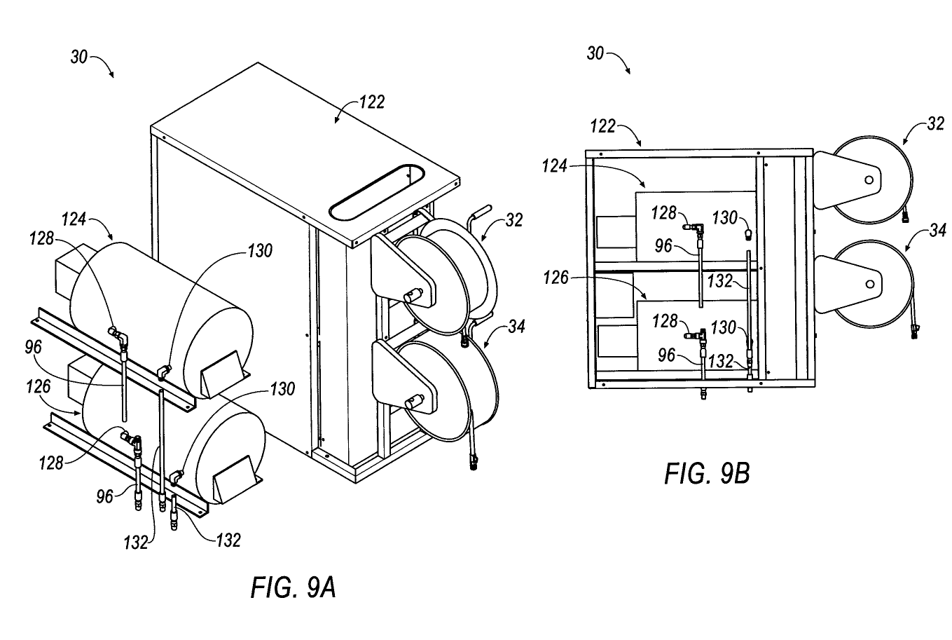

Referring to FIGS. 9A-9B, the burner unit 30 is shown according to an embodiment. The burner unit 30 may be an assembly of a plurality a components 122-132. The plurality of components 122-132 may include, but is not limited to: a housing 122, a first burner 124, a second burner 126. Each of the first burner 124 and the second burner 126 may include an inlet port 128 connected to the hose 96 of the second outlet assembly 68 of the first fluid tank 14.

Each of the first burner 124 and the second burner 126 may also include an outlet port 130 connected to a hose 132. The hose 132 of the first burner 124 may be connected to the third reel assembly 36; the hose 132 of the second burner 126 may be connected to the fourth reel assembly 38.

Each of the first and second burner units 124, 126 may include a diesel-fired water heater. The first and second burner units 124, 126 may be limited to heat a fluid to a maximum temperature to be no more than approximately about 140° F.

Referring to FIGS. 9A-9B, the first reel assembly 32 and the second reel assembly 34 may also be connected to the housing 122. The first reel assembly 32 may provide compressed air from the air compressor 204 (see, e.g., FIG. 16), and, as such, may be referred to as a compressed air hose reel assembly. The second reel assembly 34 may provide an engine flush fluid, and, as such, may be referred to as an engine flush hose reel assembly.

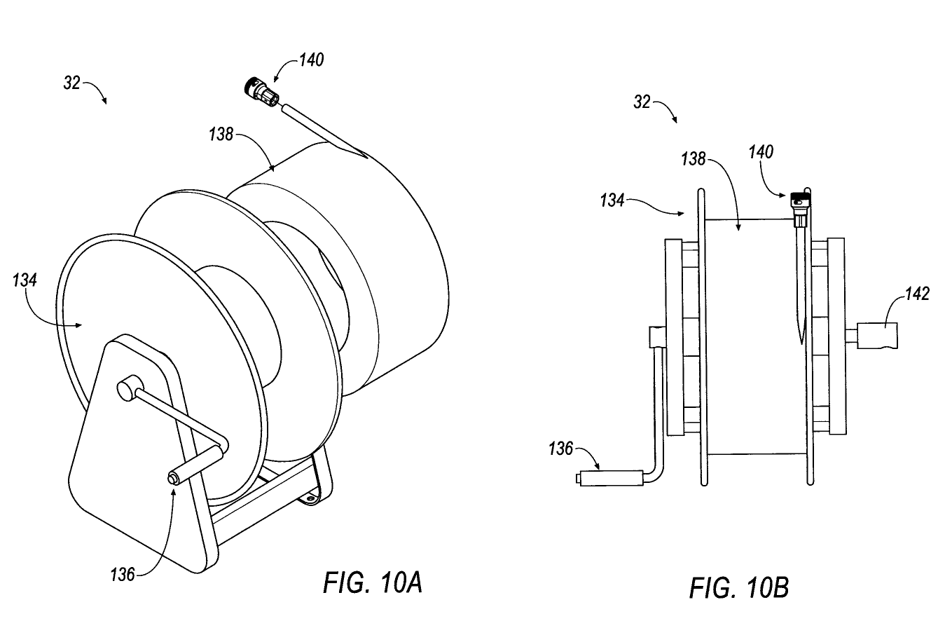

Referring to FIGS. 10A-10B, the compressed air hose reel assembly 32 is shown according to an embodiment. The compressed air hose reel assembly 32 may include, but is not limited to: a reel body 134, a manual crank handle 136, a hose 138, a twist lock coupler outlet 140 and an inlet port 142 that is connected to the an air compressor (not shown) of the power unit 28.

Referring to FIGS. 11A-11B, the engine flush hose reel assembly 34 is shown according to an embodiment. The engine flush hose reel assembly 34 may include, but is not limited to: a reel body 144, a manual crank handle 146, a hose 148, a mini ball valve 150, a quick connect coupler outlet 152 and an inlet port 154 from the hose 116 that is associated with the third fluid tank 18. The inlet port 154 provides communication of the fluid within the third fluid tank 18 to an inlet end (not shown) of the hose 148 such that the fluid of the third fluid tank 18 is fed through and out of the hose 148 at the quick connect coupler outlet 152.

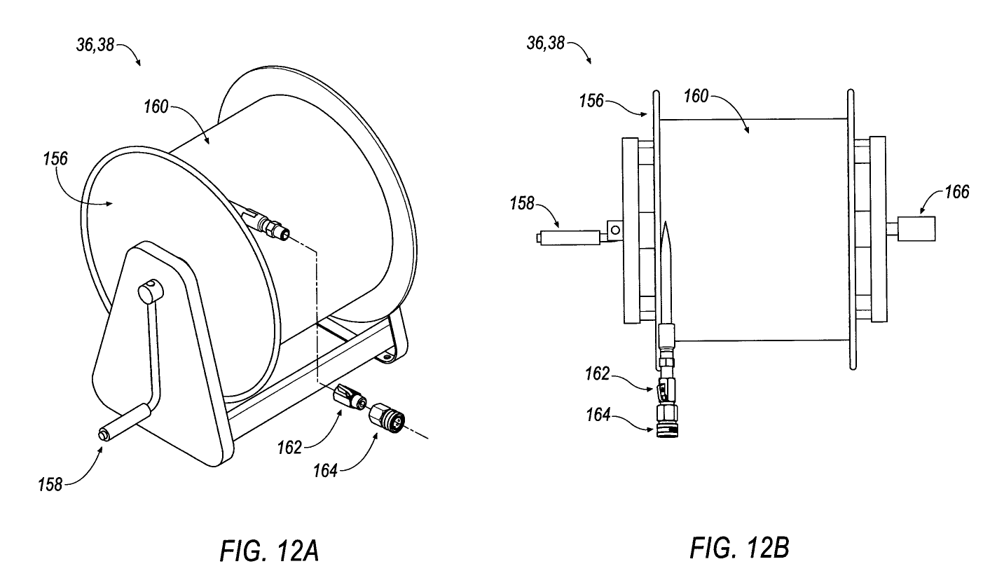

Referring to FIGS. 12A-12B the third reel assembly 36 and the fourth reel assembly 38 are shown according to an embodiment. Each of the third and fourth reel assemblies 36, 38 may dispense hot or cold fluid from the first fluid tank 14; accordingly, as seen, for example, in FIG. 16, the fluid may be routed from the first fluid tank 14 through the burner unit 30 and out of one or more of the third and fourth reel assemblies 36, 38. In an implementation, each of the third and fourth reel assemblies 36, 38 may be referred to as a rinse hose assembly.

Each of the rinse hose assemblies 36, 38 may include, but is not limited to: a reel body 156, a manual crank handle 158, a hose 160, a mini ball valve 162, a quick-disconnect coupler outlet 164 and an inlet port 166. The inlet port 166 may be connected to the burner unit 30 (e.g., the hose 132 of the first burner 124 may be connected to the inlet port 166 of the rinse hose assembly 36; the hose 132 of the second burner 126 may be connected to the inlet port 166 of the rinse hose assembly 38). The inlet port 166 provides the hot or cold fluid to an inlet end (not shown) of the hose 160 such that the hot or cold fluid is fed through and out of the hose 160 at the quick connect coupler outlet 164.

Referring to FIGS. 13A-13B, a fifth reel assembly 40 is shown according to an embodiment. The fifth reel assembly 40 may dispense the foam from the foam generator 202 (see, e.g., FIG. 16) of the power unit 28 that receives an amount of water from the fluid tank 14 and an amount of soap concentrate solution from the second fluid tank 16 and compressed air from the air compressor 204; accordingly, the fluid may be routed from the fluid tanks 14, 16, to the foam generator 202 of the power unit 28 and dispensed out of the fifth reel assembly 40. In an implementation, each of the fifth reel assemblies 40 may be referred to as a hose reel assembly.

The hose reel assembly 40 may include, but is not limited to: a reel body 168, a manual crank handle 170, a hose 172, a hose barb 174, a ball valve outlet 176 and an inlet port 178. The inlet port 178 may be connected to a hose (not shown) extending from the foam generator of the power unit 28. The inlet port 178 provides the foam from the foam generator to an inlet end (not shown) of the hose 172 such that the foam is fed through and out of the hose 172 at the ball valve outlet 176.

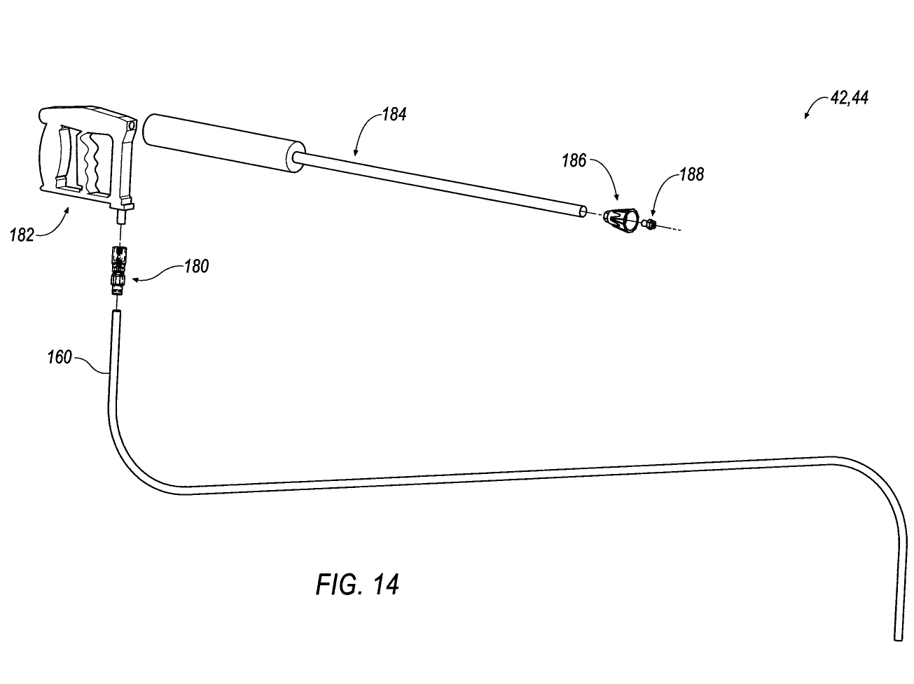

Referring to FIG. 14 the first high pressure wash assembly 42 and the second high pressure wash assembly 44 are shown according to an embodiment. Each of the first and second high pressure wash assemblies 42, 44 may include, but is not limited to: an inlet swivel 180, a gun portion 182, a wand portion 184, a nozzle protector 186 and an outlet nozzle 188. The inlet swivel 182 may be connected to the quick connect coupler outlet 164 of the hose 160 of one or the rinse hose assemblies 36, 38.

Referring to FIGS. 15A-15B, the wash gun assembly 46 is shown according to an embodiment. The wash gun assembly 46 may include, but is not limited to: a cam lock inlet portion 190, a gun portion 192 and an outlet foamer nozzle 194. The cam lock inlet portion 190 may be connected to the ball valve outlet 176 of the hose 172 of the hose reel assembly 40.

Functionally, the system 10 permits an operator to execute a low pressure exterior cleaning and corrosion control of an aircraft. In an embodiment, a nozzle pressure of the wash gun assembly 46 and the first and high pressure wash assemblies 42, 44 is not greater than 175 psi. The a temperature of one or more of the fluids may be selectively controlled to be at about ambient temperature but not greater than about 140° F.

The power unit 28 and the burner unit 30 permits the system 10 to be self contained; as a result, the system 10 obviates a need to obtain, for example, a connection to a secondary source (e.g., shore power). Although the first, second, third and fourth tanks 14-20 may include any desirable capacity, the fluid stored in the tanks 14-20 may be replenished at any time, as desired, by an operator. Accordingly, the system 10 provides the operator significant flexibility to perform many aircraft wash servicing/maintenance functions from of one, self-contained machine.

I. Preparing the System—Filling the Fluid Tanks

Prior to utilizing the system 10, the fluid tanks 14-20 are filled with fluid. The first fluid tank 14 may be filled with water from a source (not shown); accordingly the first fluid tank 14 may be referred to as a water tank.

The refill hose 56 may be connected to the source at a first end (not shown) of the hose 56. A second end of the hose is connected to the refill port 54. Alternatively, a man-hold access port cover 70 that closes out the man-hole access port 70 could be removed and the water could be deposited into the water tank 14 through the man-hold access port. If the water enters the water tank 14 by way of the refill port 54, an auto-fill valve (not shown) will actuate in order to cease the filling of the water tank 14 with the water in order to prevent the water tank 14 from being over-filled.

The second fluid tank 16 may be referred to as a soap tank. The operator may fill the soap tank 16 with any desirable soap concentrate solution. Upon actuating the power unit 28, an amount of water may be drawn from the water tank 14 and an amount of soap concentrate solution may be drawn from the soap tank 16. The amount of water and the amount of soap concentrate solution may be mixed by the foam generator 202 and subjected to compressed air from the air compressor 204 prior to being evacuated from the system 10 and upon the aircraft.

The third fluid tank 18 may be referred to as a gas path cleaner tank. The operator may fill the gas path cleaner tank with any desirable gas path cleaner solution.

II. Preparing the System—Attaching the Guns and Hoses

The wash gun assembly 46 and the first and high pressure wash assemblies 42, 44 may be stored in one or more of the first storage unit 22, the second storage unit 24 and the third storage unit 26. Alternatively, the system 10 may be provided with one or more holsters (not shown) for stowing one or more of the wash gun assembly 46 and the first and high pressure wash assemblies 42, 44 upon an exterior surface of the system 10 (e.g., upon the member 12). As described above the wash gun assembly 46 may include a cam lock inlet portion 190 that may be connected to the ball valve outlet 176 of the hose 172 of the hose reel assembly 40, and, each of the first and second high pressure wash assemblies 42, 44 may include an inlet swivel 182 that may be connected to the quick connect coupler outlet 164 of the hose 160 of one or the rinse hose assemblies 36, 38.

III. Using the Exterior Wash Function of the System

The operator may start the system 10 by arranging an “on/off” switch from the control panel 118 in an “on” position. The engine associated with the power unit 28 may undergo a pre-heating/warm-up process. During the pre-heating/warm-up process, an indicator (e.g., a green light) may flash (i.e., transition from an on state to an off state). Once the indicator no longer flashes (i.e., the indicator remains in the on state) remains illuminated, the operator may turn an engine switch from an “off” position to a “start” position.

The operator may then locate a “hot” water switch associated with each of the first burner 124 and the second burner 126 of the burner unit 30. Accordingly, the operator may be provided with the election of having neither, one, or both of the first burner 124 and the second burner providing “hot” water or “cold”/“ambient temperature” water for rinsing the aircraft with water being dispensed from the first and second high pressure wash assemblies 42, 44.

The operator may then unwind an amount of a length of the hose 172 from the hose reel assembly 40 and subsequently squeeze the gun portion 192 of the wash gun assembly 46. The outlet foamer nozzle 194 of the wash gun assembly 46 may dispense an amount of the water that was mixed with the soap concentrate solution by the foam generator 202 in order to apply cleansing foam to the aircraft. The operator may selectively adjust the output pressure of the cleansing foam by, for example, adjusting an orientation (e.g., by twisting) the outlet foamer nozzle 194. When the operator is satisfied with the amount of cleansing foam applied to the aircraft, the operator may release the applied squeezing pressure to the gun portion 192 and subsequently wind the hose 172 back upon the reel assembly 40.

The operator may then unwind an amount of a length of the hose 160 from a selected the rinse hose assemblies 36, 38 and subsequently squeeze the gun portion 182 of the selected high pressure wash assembly 42/44. The outlet nozzle 188 of the selected high pressure wash assembly 42/44 may dispense an amount of water upon the aircraft for rinsing the cleansing foam from the aircraft. The wand portion 184 of the selected high pressure wash assembly 42/44 may be manipulated in order to adjust the output pressure of the water being dispensed upon the aircraft. When the operator is satisfied with the amount of water applied to the aircraft, the operator may release the applied squeezing pressure to the gun portion 182 and subsequently wind the hose 160 back upon the selected the rinse hose assemblies 36, 38.

The operator may stop the system 10 by arranging the “on/off” switch from the control panel 118 in an “off” position. The engine associated with the power unit 28 will subsequently shut down. Prior to stowing the wash gun assembly 46 and the first and high pressure wash assemblies 42, 44 in the holsters or one or more of the first storage unit 22, the second storage unit 24 and the third storage unit 26, the operator may squeeze the gun portions 182, 192 in order to release any fluid pressure that may still reside in the hoses 160, 172.

IV. Using the Turbine Engine Flush Function of the System

In an implementation, the engine turbine flush function of the system 10 is simplified by providing controls that are completely separate of the exterior wash function described above. If desired, the engine turbine flush function of the system 10 may be conducted by utilizing the engine of the power unit 28, or, alternatively, a battery (not shown) of the power unit 28.

The operator may unwind an amount of a length of the hose 138 from the compressed air hose reel assembly 32. The operator may also unwind an amount of a length of the hose 148 from the engine flush hose reel assembly 34. The operator then connects both of the hoses 138, 148 to the aircraft.

The operator then selects, from the control panel 118 of the power unit, the fluid source by moving a fluid source dial to the “chemical” position (i.e., another position for the fluid source on the control panel is the “water” position). The operator may start the system 10 by arranging an “on/off” switch from the control panel 118 in an “on” position. The operator then arranges an “on/off” flush control switch on the control panel 118 in an “on” position. A flush motor/pump assembly (not shown) of the power unit 28 is then actuated; the pump will charge into the engine flush discharge line. The pump may provide a flow rate of the gas path cleaner solution to the turbine at about of a maximum flow rate of approximately about 2.5-gallons-per-minute and not exceeding a pressure of approximately about 45 psi.

Upon the discharge line of the aircraft being purged, the operator may then arrange the “on/off” flush control switch on the control panel 118 in an “off” position such that the pump of the flush motor/pump assembly of the power unit 28 is de-actuated. The operator then disconnect both of the hoses 138, 148 from the aircraft. The operator may wind the hose 138 upon the compressed air hose reel assembly 32 as well the hose 148 upon the engine flush hose reel assembly 34. The operator may stop the system 10 by arranging the “on/off” switch from the control panel 118 in an “off” position. The engine associated with the power unit 28 will subsequently shut down.

V. Draining the Tanks for Storage

The water tank 14 may be drained by opening the ball valve 88 of the second outlet assembly 68. Subsequently, the water within the water tank 14 may be completely evacuated.

In order to drain the soap concentrate solution from within the second fluid tank 16 and/or the gas path cleaner solution from the gas path cleaner tank 18, the operator may firstly close the ball valve 108 as well as the ball valve 88 of the water tank 14. The operator may then remove the line strainer 112 such that the tanks 16, 18 may be drained of its/their fluid. Once the fluid is drained from the tank(s) 16, 18, the operator replaces the line strainer 112 and then opens the ball valves 88, 108.

The present invention has been described with reference to certain exemplary embodiments thereof However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A vehicle maintenance system comprising:
a power unit including a power resource connected to and for driving:
a pump,
a foam generator, and
an air compressor,
wherein the air compressor includes an air output connected to the foam generator for supplying compressed air to the foam generator, wherein the pump includes a fluid output connected to the foam generator;
a first fluid tank including a first fluid output and a second fluid output, wherein the first fluid output is connected to the pump;
a second fluid tank including a fluid output, wherein the fluid output of the second fluid tank is connected to the foam generator;
a hose reel assembly including an outlet port and an inlet port, wherein the inlet port is connected to an outlet port of the foam generator;
a wash gun assembly including an inlet port, wherein the inlet port of the wash gun assembly is connected to the outlet port of the foaming hose reel assembly; and
a support member that is connected to and supports: the power unit, the first fluid tank, the second fluid tank and the hose reel assembly.

2. The vehicle maintenance system according to claim 1, wherein the first fluid tank stores water, wherein the second fluid tank stores a cleansing medium, wherein the foam generator mixes: the water from the first fluid tank, the cleansing medium from the second fluid tank, and the compressed air from the air compressor, wherein the foam generator mixes the water, cleansing medium and compressed air to create a foam solution.

3. The vehicle maintenance system according to claim 1 further comprising
a burner unit including a fluid input and a fluid output, wherein the fluid input of the burner unit is connected to the second fluid output of the first fluid tank.

4. The vehicle maintenance system according to claim 3, wherein the burner unit receives fluid from the first fluid tank, wherein the burner unit is manipulatable to selectively increase a temperature of the fluid from the first fluid tank.

5. The vehicle maintenance system according to claim 3 further comprising
a rinse assembly including an inlet port, wherein the inlet port of the rinse assembly is connected to the fluid outlet of the burner unit.

6. The vehicle maintenance system according to claim 3 further comprising:
a third fluid tank including a fluid output, wherein the third fluid tank is connected to the support member; and
a turbine engine flush assembly connected to the burner unit, wherein the turbine engine flush assembly includes a fluid inlet and a fluid outlet, wherein the fluid output of the third fluid tank is connected to the fluid inlet of the turbine engine flush assembly.

7. The vehicle maintenance system according to claim 6, wherein the third fluid tank stores turbine engine flush fluid, wherein fluid outlet of the turbine engine flush assembly dispenses the turbine engine flush fluid from the third fluid tank.

8. The vehicle maintenance system according to claim 3 further comprising:
a compressed air assembly, wherein the compressed air assembly includes a fluid inlet and a fluid outlet, wherein the fluid inlet of the compressed air assembly is connected to the air output of the air compressor of the compressed air assembly.

9. The vehicle maintenance system according to claim 8, wherein fluid outlet of the compressed air assembly dispenses compressed air from the air compressor.

10. The vehicle maintenance system according to claim 1 further comprising:
a fourth fluid tank including a fluid outlet, wherein the fluid outlet of the fourth fluid tank is connected to a fluid inlet of the power resource of the power unit, wherein the power resource is a prime mover, wherein the prime mover is an engine, wherein the fourth fluid tank stores engine fuel.

11. The vehicle maintenance system according to claim 1 further comprising:
a plurality of wheels connected to the support member.

12. The vehicle maintenance system according to claim 1 further comprising:
at least one storage unit connected to the support member.

13. A method for operating the vehicle maintenance system of claim 1, comprising the steps of:
arranging water in the first fluid tank,
arranging a cleansing medium in the second fluid tank,
drawing the water and the cleansing medium into the foam generator,
mixing the water and cleansing medium in the foam generator;
subjecting the mixed water and cleansing medium in the foam generator to compressed air from the air compressor for
creating a foam solution; and.
drawing the foam solution from the foam generator and dispensing the foam solution from the wash gun assembly.

14. The method according to claim 13 further comprising the steps of:
drawing the water from into a burner unit;
manipulating the burner unit for selectively increasing a temperature of the fluid from the first fluid tank;
drawing the water from the burner unit to a rinse assembly; and
dispensing the water from the rinse assembly.

15. The method according to claim 13 further comprising the steps of:
arranging turbine engine flush fluid in a third fluid tank;
drawing the turbine engine flush fluid from the third fluid tank; and
dispensing the turbine engine flush fluid from a turbine engine flush assembly.

16. The method according to claim 1 further comprising the step of:
arranging the support member upon a plurality of wheels; and
moving the support member from a first location to a second location.
